(19) United States
(12) Patent Application Publication
(10) Pub. No.: US 2024/0135591 A1
(43) Pub. Date: Apr. 25, 2024

(54) METHOD, APPARATUS, AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Yingzhan XU, Beijing (CN); Kai ZHANG, Los Angeles, CA (US); Li ZHANG, Los Angeles, CA (US)

(21) Appl. No.: 18/399,563

(22) Filed: Dec. 28, 2023

Related U.S. Application Data
(63) Continuation of application No. PCT/CN2022/103766, filed on Jul. 4, 2022.

(30) Foreign Application Priority Data
Jul. 3, 2021 (WO) PCT/CN2021/104401

(51) Int. Cl. G06T 9/00

(52) U.S. Cl. CPC G06T 9/001

(57) ABSTRACT

Embodiments of the present disclosure provide a method for point cloud coding. The method comprises: classifying, during a conversion between a current frame of a point cloud sequence and a bitstream of the point cloud sequence, a target point in the current frame into a first set of classes based on a second set of thresholds, the number of thresholds in the second set being larger than the number of classes in the first set; and performing the conversion based on the classification. Compared with the conventional solution, the proposed method can advantageously improve the accuracy of global motion estimation and coding quality.

### CROSS-REFERENCE TO RELATED APPLICATIONS

This application is a continuation of International Application No. PCT/CN2022/103766, filed on Jul. 4, 2022, which claims the benefit of International Application No. PCT/CN2021/104401 filed on Jul. 4, 2021. The entire contents of these applications are hereby incorporated by reference in their entireties.

### FIELD

Embodiments of the present disclosure relates generally to point cloud coding techniques, and more particularly, to classification-based global motion estimation methods for point cloud coding.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

In a first aspect, a method for point cloud coding is proposed. The method comprises: classifying, during a conversion between a current frame of a point cloud sequence and a bitstream of the point cloud sequence, a target point in the current frame into a first set of classes based on a second set of thresholds, the number of thresholds in the second set being larger than the number of classes in the first set; and performing the conversion based on the classification.

The method in accordance with the first aspect of the present disclosure increases the number of thresholds used for classifying a point in the frame. Compared with the conventional solution where the number of thresholds is equal to the number of classes, the proposed method can advantageously enable more accurate classification of the points, and thus improve the accuracy of global motion estimation and coding quality.

In a second aspect, another method for point cloud coding is proposed. The method comprises: classifying, during a conversion between a current frame of a point cloud sequence and a bitstream of the point cloud sequence, a target point in the current frame into a first set of classes based on a second set of thresholds, the number of thresholds in the second set being equal to the number of classes in the first set, at least one threshold in the second set is generated based on a further frame of the point cloud sequence; and performing the conversion based on the classification.

According to the method in accordance with the second aspect of the present disclosure, in addition to the current frame, a further frame of the point cloud sequence is also used to generate the threshold used for classifying a point. Compared with the conventional solution where only the current frame is used to generate the threshold, the proposed method can advantageously generate more reasonable thresholds which enable more accurate classification of the points, and thus improve the accuracy of global motion estimation and coding quality.

In a third aspect, another method for point cloud coding is proposed. The method comprises: classifying, during a conversion between a current frame of a point cloud sequence and a bitstream of the point cloud sequence, a target point in the current frame into a first set of classes based on a second set of thresholds, the number of thresholds in the second set being equal to the number of classes in the first set, at least one threshold in the second set being generated based on a histogram of geometry features of points in the point cloud sequence, the histogram being generated based on a characteristic of the point; and performing the conversion based on the classification.

According to the method in accordance with the third aspect of the present disclosure, the characteristic of points to be used for generating the histogram of geometry features of points is taken into consideration. Compared with the conventional solution, the proposed method can advantageously generate more reasonable thresholds which enable more accurate classification of the points, and thus improve the accuracy of global motion estimation and coding quality.

In a fourth aspect, another method for point cloud coding is proposed. The method comprises: classifying, during a conversion between a current frame of a point cloud sequence and a bitstream of the point cloud sequence, at least a part of points in the current frame based on a set of planar regions, each of the set of planar regions being three-dimensional and having a height equal to a height of a bounding box of the current frame; and performing the conversion based on the classification.

The method in accordance with the fourth aspect of the present disclosure utilizes planar regions as process units to perform the classification process. Compared with the conventional solution where a block is used, the proposed method can advantageously reduce the number of iterations in the classification process and thus reduce the complexity of classification process and improve the coding efficiency.

In a fifth aspect, another method for point cloud coding is proposed. The method comprises: classifying, during a conversion between a current frame of a point cloud sequence and a bitstream of the point cloud sequence, reference points in a reference frame of the current frame into a set of classes; generating a set of reference samples based on reference points classified into the same class; and performing the conversion based on the set of reference samples.

According to the method in accordance with the fifth aspect of the present disclosure, reference samples are generated based on reference points classified into the same class. Thereby, the proposed method can advantageously avoid mismatching in global motion estimation, and thus improve the accuracy of global motion estimation and coding quality.

In a sixth aspect, another method for point cloud coding is proposed. The method comprises: determining, during a conversion between a current frame of a point cloud sequence and a bitstream of the point cloud sequence, global motion information for the current frame based on a plurality of reference frame of the current frame; and performing the conversion based on the global motion information.

According to the method in accordance with the sixth aspect of the present disclosure, the global motion estimation is performed on the frame with more than one reference frame. Compared with the conventional solution where only one reference frame is used, the proposed method can advantageously improve the accuracy of global motion estimation and coding quality.

In a seventh aspect, an apparatus for processing point cloud data is proposed. The apparatus comprises a processor and a non-transitory memory with instructions thereon. The instructions upon execution by the processor, cause the processor to perform a method in accordance with the first, second, third, fourth, fifth or sixth aspect of the present disclosure.

In an eighth aspect, a non-transitory computer-readable storage medium is proposed. The non-transitory computer-readable storage medium stores instructions that cause a processor to perform a method in accordance with the first, second, third, fourth, fifth or sixth aspect of the present disclosure.

In a ninth aspect, a non-transitory computer-readable recording medium is proposed. The non-transitory computer-readable recording medium stores a bitstream of a point cloud sequence which is generated by a method performed by a point cloud processing apparatus. The method comprises: classifying a target point in a current frame of the point cloud sequence into a first set of classes based on a second set of thresholds, the number of thresholds in the second set being larger than the number of classes in the first set; and generating the bitstream based on the classification.

In a tenth aspect, a method for storing a bitstream of a point cloud sequence is proposed. The method comprises: classifying a target point in a current frame of the point cloud sequence into a first set of classes based on a second set of thresholds, the number of thresholds in the second set being larger than the number of classes in the first set; generating the bitstream based on the classification; and storing the bitstream in a non-transitory computer-readable recording medium

In an eleventh aspect, another non-transitory computer-readable recording medium is proposed. The non-transitory computer-readable recording medium stores a bitstream of a point cloud sequence which is generated by a method performed by a point cloud processing apparatus. The method comprises: classifying a target point in a current frame of the point cloud sequence into a first set of classes based on a second set of thresholds, the number of thresholds in the second set being equal to the number of classes in the first set, at least one threshold in the second set is generated based on a further frame of the point cloud sequence; and generating the bitstream based on the classification.

In a twelfth aspect, another method for storing a bitstream of a point cloud sequence is proposed. The method comprises: classifying a target point in a current frame of the point cloud sequence into a first set of classes based on a second set of thresholds, the number of thresholds in the second set being equal to the number of classes in the first set, at least one threshold in the second set is generated based on a further frame of the point cloud sequence; generating the bitstream based on the classification; and storing the bitstream in a non-transitory computer-readable recording medium.

In a thirteenth aspect, another non-transitory computer-readable recording medium is proposed. The non-transitory computer-readable recording medium stores a bitstream of a point cloud sequence which is generated by a method performed by a point cloud processing apparatus. The method comprises: classifying a target point in a current frame of the point cloud sequence into a first set of classes based on a second set of thresholds, the number of thresholds in the second set being equal to the number of classes in the first set, at least one threshold in the second set being generated based on a histogram of geometry features of points in the point cloud sequence, the histogram being generated based on a characteristic of the point; and generating the bitstream based on the classification.

In a fourteenth aspect, another method for storing a bitstream of a point cloud sequence is proposed. The method comprises: classifying a target point in a current frame of the point cloud sequence into a first set of classes based on a second set of thresholds, the number of thresholds in the second set being equal to the number of classes in the first set, at least one threshold in the second set being generated based on a histogram of geometry features of points in the point cloud sequence, the histogram being generated based on a characteristic of the point; generating the bitstream based on the classification; and storing the bitstream in a non-transitory computer-readable recording medium.

In a fifteenth aspect, another non-transitory computer-readable recording medium is proposed. The non-transitory computer-readable recording medium stores a bitstream of a point cloud sequence which is generated by a method performed by a point cloud processing apparatus. The method comprises: classifying at least a part of points in a current frame of the point cloud sequence based on a set of planar regions, each of the set of planar regions being three-dimensional and having a height equal to a height of a bounding box of the current frame; and generating the bitstream based on the classification.

In a sixteenth aspect, another method for storing a bitstream of a point cloud sequence is proposed. The method comprises: classifying at least a part of points in a current frame of the point cloud sequence based on a set of planar regions, each of the set of planar regions being three-dimensional and having a height equal to a height of a bounding box of the current frame; generating the bitstream based on the classification; and storing the bitstream in a non-transitory computer-readable recording medium.

In a seventeenth aspect, another non-transitory computer-readable recording medium is proposed. The non-transitory computer-readable recording medium stores a bitstream of a point cloud sequence which is generated by a method performed by a point cloud processing apparatus. The method comprises: classifying reference points in a reference frame of a current frame of the point cloud sequence into a set of classes; generating a set of reference samples based on reference points classified into the same class; and generating the bitstream based on the set of reference samples.

In an eighteenth aspect, another method for storing a bitstream of a point cloud sequence is proposed. The method comprises: classifying reference points in a reference frame of a current frame of the point cloud sequence into a set of classes; generating a set of reference samples based on reference points classified into the same class; generating the bitstream based on the set of reference samples; and storing the bitstream in a non-transitory computer-readable recording medium.

In a nineteenth aspect, another non-transitory computer-readable recording medium is proposed. The non-transitory computer-readable recording medium stores a bitstream of a point cloud sequence which is generated by a method performed by a point cloud processing apparatus. The method comprises: determining global motion information for a current frame of the point cloud sequence based on a plurality of reference frame of the current frame; and generating the bitstream based on the global motion information.

In a twentieth aspect, another method for storing a bitstream of a point cloud sequence is proposed. The method comprises: determining global motion information for a current frame of the point cloud sequence based on a plurality of reference frame of the current frame; generating the bitstream based on the global motion information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 is a schematic diagram illustrating an example of planar regions and blocks in a point cloud;

FIG. 5 is a schematic diagram illustrating an example of generation blocks for a point cloud;

FIG. 6 is a schematic diagram illustrating an example of generation reference blocks for current block;

FIG. 7 is a schematic diagram illustrating an example of generation planar regions for a point cloud;

FIG. 8 is a schematic diagram illustrating an example of generation reference planar regions for current planar region;

FIG. 9 illustrates a flowchart of a method for point cloud coding in accordance with some embodiments of the present disclosure;

FIG. 10 illustrates another flowchart of a method for point cloud coding in accordance with some embodiments of the present disclosure;

FIG. 11 illustrates another flowchart of a method for point cloud coding in accordance with some embodiments of the present disclosure;

FIG. 12 illustrates another flowchart of a method for point cloud coding in accordance with some embodiments of the present disclosure;

FIG. 13 illustrates another flowchart of a method for point cloud coding in accordance with some embodiments of the present disclosure;

FIG. 14 illustrates another flowchart of a method for point cloud coding in accordance with some embodiments of the present disclosure; and

FIG. 15 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

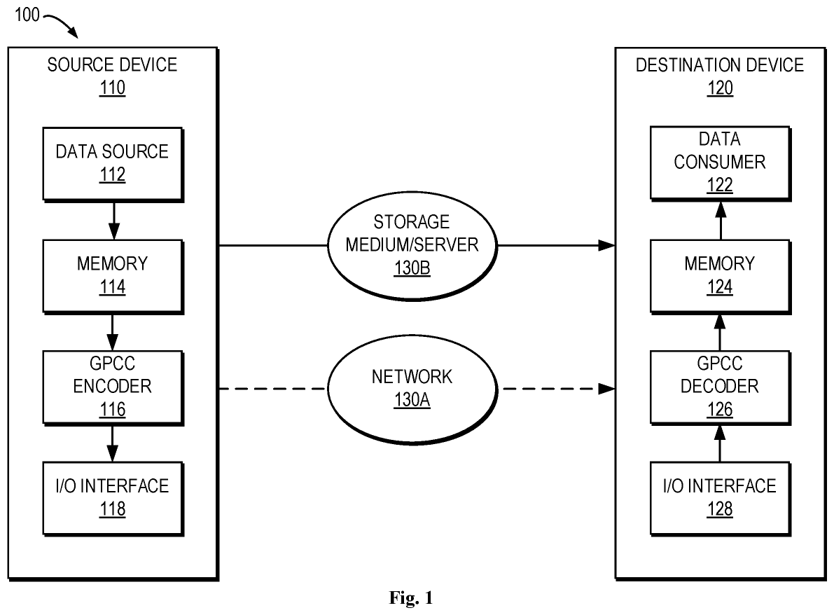

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

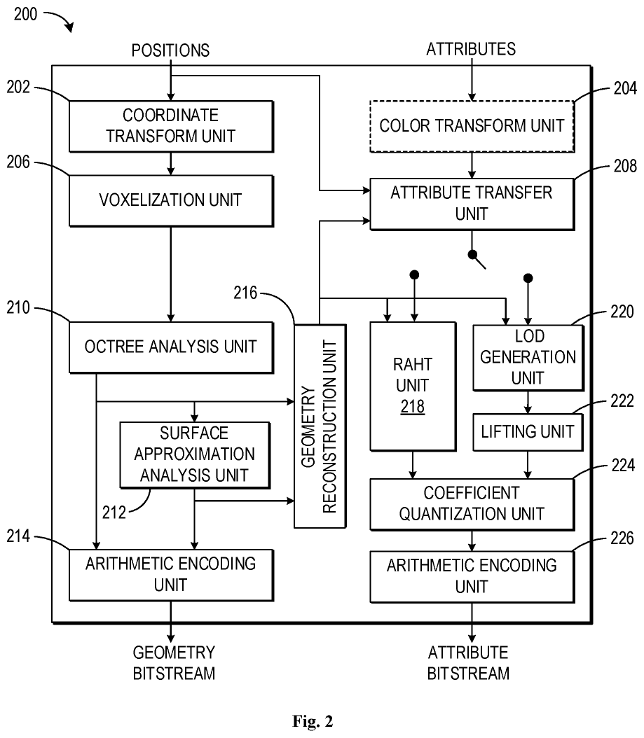

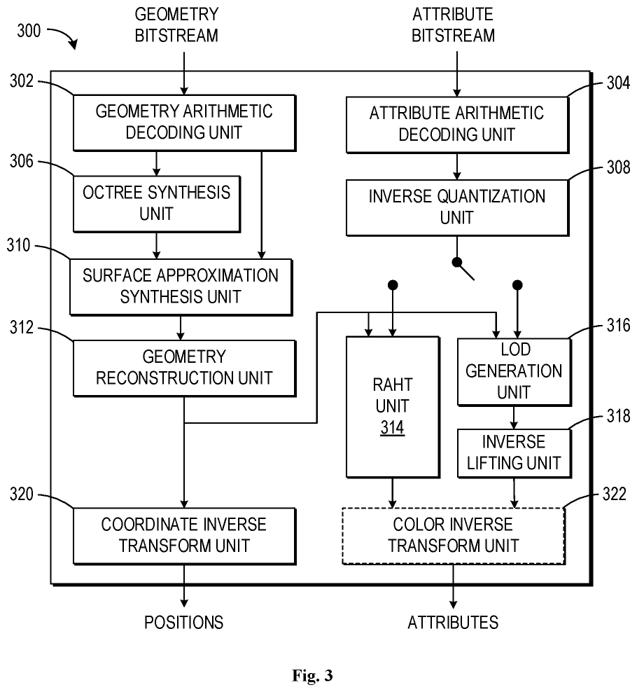

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octree. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octree analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream. Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octree.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. Summary

This disclosure is related to point cloud coding technologies. Specifically, it is about motion estimation process in point cloud inter coding. The ideas may be applied individually or in various combination, to any point cloud coding standard or non-standard point cloud codec, e.g., the being-developed Geometry-based Point Cloud Compression (G-PCC).

### 2. Abbreviations

G-PCC Geometry-based Point Cloud Compression
MPEG Moving Picture Experts Group
3DG 3D Graphics Coding group
CFP Call For Proposal
V-PCC Video-based Point Cloud Compression
CE Core Experiment
EE Exploration Experiment
inter-EM inter Exploration Model
LMS Least Mean Square

### 3. Background

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions.

To explore the future point cloud coding technologies in G-PCC, Core Experiment (CE) 13.5 and Exploration Experiment (EE) 13.2 were formed to develop inter prediction technologies in G-PCC. Since then, many new inter prediction methods have been adopted by MPEG and put into the reference software named inter Exploration Model (inter-EM).

Sparse Lidar point cloud data is typically captured by Lidar sensors attached to moving vehicles. In such data, points data always move along with the movement of the objects and the movement of the moving vehicle. When the motions of the reference frame are estimated and compensated, the residual of inter prediction can be reduced and the efficiency of inter coding can be improved significantly. The process evaluation of these motions is defined as “global motion estimation” in inter-EM.

In one point cloud frame, the points data of road and objects commonly have different motions. A division of a point cloud into road and objects will improve the accuracy of the global motion which leads to a great enhancement of the compression efficiency. In one example, the global motion estimation module can use a two-threshold method to obtain the classification of object points and road points. Two thresholds named top_thr and bottom_thr are derived based on the histogram of the heights (i.e., z values) of points. If the height of a point is smaller than bottom_thr or greater than top_thr, it is labeled as an object point, otherwise, it is classified as a road point. The derivation of the thresholds is based on the histogram:
1. Obtain the histogram for the points with the height being in the range of (B, T) with a specific histogram bin size. B and T are two preset thresholds to select the points to be used for calculating top_thr and bottom_thr.
2. Calculate the standard deviation (std) of the histogram.
3. Find the peak bin (P) of the histogram where the number of points achieve the maximum.
4. The thresholds are calculated as follows:

top_thr=Min(T,P+1.5*std)

bottom_thr=Max(B,P−1.5*std)

In classification process, the encoder scans block by block to derive the point array, pc_likely_world, which contains object points being used in the global motion estimation process. For a point in the current block, if its height value fit the two-thresholds conditions and there is at least one point in the reference block (collocated block with an extension in the reference frame), this point will be added to pc_likely_world.

After the points are classified into the road and objects, only the points with object label are used in the global motion estimation process. The Least Mean Square (LMS) algorithm is used to estimate the global motion. The number of LMS iterations for the estimation and the number of samples used for each iteration of the estimation is preset. In each iteration, the samples are subsampled from points in pc_likely_world. And for each sample, its responding reference sample point will be found in reference frame, which is the point with the smallest distance from the current sample. The global motion matrix is calculated by LMS algorithm with the samples and reference samples. Then the global motion matrix is applied to the object points in reference frame to get the reference frame with motion compensation.

### 4. Problems

The designs for global estimation described above have the following problems:
1. The classification results are not accuracy enough. Some object points with low height value may be labeled as road points, e.g., some object points at the junction of buildings and road. The wrong classification will reduce the accuracy of global motion estimation.
2. The complexity of classification process is high. The classification process that the encoder scans block by block introduces many iterations. These iterations cause high complexity.
3. The matching results between the samples and the reference samples are not accuracy enough. The samples are subsampled from the object points in the current frame. The reference samples are generated by scanning all points in the reference frame, including both object points and road points. Therefore, the reference sample of a sample may be labeled as a road point in the reference frame while the sample is always labeled as an object point. The wrong matching results will reduce the accuracy of global motion estimation.

### 5. Exemplary Embodiments

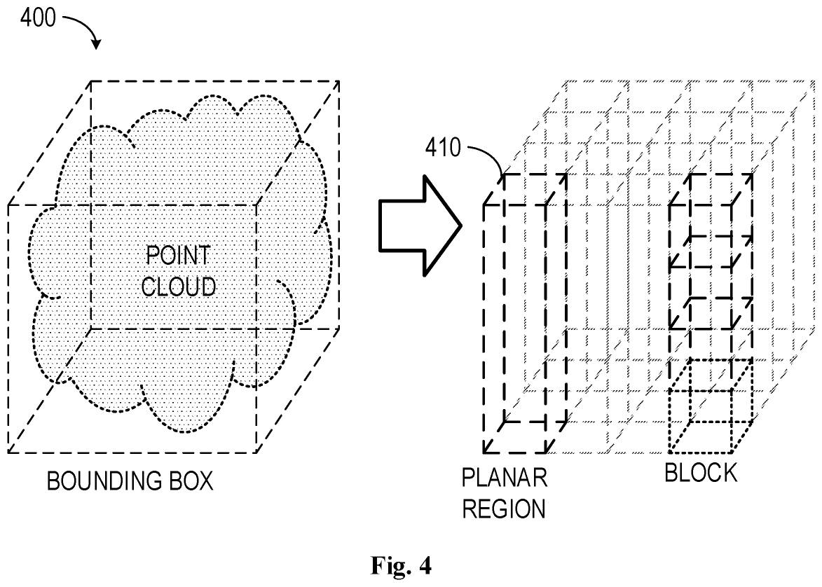

To solve the above problems and some other problems not mentioned, methods as summarized below are disclosed. The embodiments should be considered as examples to explain the general concepts and should not be interpreted in a narrow way. Furthermore, these embodiments can be applied individually or combined in any manner
1) N thresholds may be used to classify the points into the M classes, such as two (M=2) classes: object points and road points wherein N is greater than M.
   a. In one example, N=5, M=2.
      i. Alternatively, furthermore, denote the five thresholds by higher_top_thr, lower_top_thr, higher_bottom_thr, lower_bottom_thr and height_change_thr. Assume that higher_top_thr>=lower_top_thr>=higher_bottom_thr>=lower_bottom_thr, the following may be applied in order:
         (1) If the height of a point is smaller than lower_bottom_thr or greater than higher_top_thr, it is labeled as an object point.
         (2) Otherwise, if the height of a point is between lower_top_thr and higher_bottom_thr, it is labeled as a road point.
         (3) Otherwise, the point is labeled as an object point if the max height difference between the point and its neighbors is higher than height_change_thr.
         (4) Otherwise, the point is labeled as a road point.
   b. In one example, the one or multiple thresholds are pre-defined or derived (e.g., based on the of the height (i.e., z values) of points).
   c. In one example, the one or multiple thresholds may be different from one point to another point.
   d. In one example, the one or multiple thresholds may be signaled from the encoder to the decoder.
   e. In one example, the one or multiple thresholds may be generated at encoder.
   f. In one example, the one or multiple thresholds may be generated at decoder.
   g. In one example, the one or multiple thresholds may be generated based on at least one of the current frame and other frames.
      i. In one example, the other frame may be a reference frame.
      ii. In one example, indication of the other frame may be signalled in the bitstream.
      iii. In one example, the other frame may be pre-defined, e.g., the reference frame with reference picture index being equal to 0.
   h. In one example, a histogram of geometry features (such as the height value of points) may be used to generate the thresholds.
      i. In one example, the histogram may be generated with all or partial points in current picture with a specific histogram bin size.
         (1) Alternatively, it may be generated with partial or all previously coded points before current point.
      ii. In one example, whether a point can be used to generate the histogram may be depended on the characteristics of the point.
         (1) In one example, if the height value of the point is within a preset range, the point may be used.
      iii. In one example, the standard deviation (std) of the histogram may be calculated to generate the thresholds.
   i. In one example, a threshold may be firstly processed, e.g., being clipped, before being used.
   j. Any geography or feature value such as the height value for a point may be compared with at least one of the thresholds to classify the point.
   k. Any geography or feature value such as the height difference value between a point and the neighbor points may be compared with at least one of the thresholds to classify the point.
   l. For above examples, they may also be applicable to current design wherein two thresholds are utilized to category a point to one of the two classes.
2) It is proposed to scan each planar region to perform the classification.
   a. In one example, there may be one or multiple reference frames for the current frame.
   b. In one example, a planar region is a cuboid space. FIG. 4 is a schematic diagram 400 illustrating an example of planar regions and blocks in a point cloud. The points in a point cloud can be clustered into multiple planar region according to their plane coordinates. A planar region can be divided into multiple blocks, which is usually a cube space, based on the height coordinates.
   c. In one example, the reference points are in a reference frame.
   d. In one example, the reference frame is composed of one or multiple planar regions, and a reference point belongs to one or multiple reference planar regions.
   e. In one example, a planar region in the current frame corresponds to one or zero reference planar regions in the reference frame.
   f. In one example, whether a point in the scanned planar region can be classified (such as use N thresholds to determine whether it is an object point) may depend on the corresponding reference planar region.
      i. In one example, a point in the scanned planar region can only be classified, if the scanned planar region corresponds to one reference planar region and there is at least one reference point belonging to the reference planar region.
   g. In one example, how to classify a point that can be classified may depend on classification conditions, such as to use N thresholds to determine whether it is an object point.
3) It is proposed to scan each point and reference point to perform the classification.
   a. In one example, there may be one or multiple reference frames for the current frame.
   b. In one example, the reference points are in a reference frame.
   c. In one example, the reference frame is composed of one or multiple reference space units (such as blocks or planar regions), and a reference point belongs to one or multiple reference space units.
   d. In one example, a reference space unit is marked (such as marked to be occupied) if at least one reference point belonging to it is scanned.
   e. In one example, a point in the current frame may correspond to one or zero reference space units.
   f. In one example, whether a point in the current frame can be classified (such as to determine whether it is an object point) may depend on its corresponding reference space unit.
      i. In one example, a scanned point can only be classified, if the scanned point corresponds to one reference space unit and there is at least one reference point belonging to the reference space unit.
   g. In one example, how to classify a point that can be classified may depend on classification conditions, such as to use N thresholds to determine whether it is an object point.
4) It is proposed to apply an estimated global motion to all points in a reference frame.
   a. In one example, the global motion matrix may be calculated by LMS algorithm with the samples and reference samples.
   b. In one example, a global motion matrix is applied to all points in the reference frame to get the reference frame with motion compensation.
5) It is proposed to generate the reference samples using (e.g., by scanning) the points with the same label in a reference frame.
   a. In one example, both samples in current frame and reference samples may be used for global motion estimation.
   b. In one example, one or more points (such as the object points) in the current frame may be downsampled to generate samples for global motion estimation.
   c. In one example, a sample corresponds to one reference sample. And its reference sample may be found in the points with the same label (such as the object points) in the reference frame.
   d. Any geography or feature value such as the Euclidean distance between two points may be used to classify the point.
      i. In one example, a point in the reference frame can be marked as the reference sample of a sample, if it has the least Euclidean distance from the sample among all points in the reference frame.

### 6. Embodiments

1) This embodiment describes an example of how to classify a point cloud frame into object points and road points by using five thresholds method.

In the example, the input is the current frame, PC_{cur} and the reference frame, PC_{ref}. The output is the point array, pc_likely_world, which contains the object points that are used for global estimation.

Firstly, generate the five thresholds for road/object classification:
1. Obtain the histogram for the values of the points in PC_{cur} with the height being in the range of (B, T) with a specific histogram bin size. Where B is preset to −4000 and T is preset to −500. The values of B and T depend on the parameters of the point cloud acquisition device
2. Calculate the standard deviation (std) of the histogram.
3. Find the peak bin (P) of the histogram where the number of points achieve the maximum.
4. The thresholds are calculated as follows:

lower_top_thr=P+1*std

higher_bottom_thr=P−1*std

higher_top_thr=Min(T,P+1.5*std)

lower_bottom_thr=Max(B,P−1.5*std)

height_change_thr=4*std

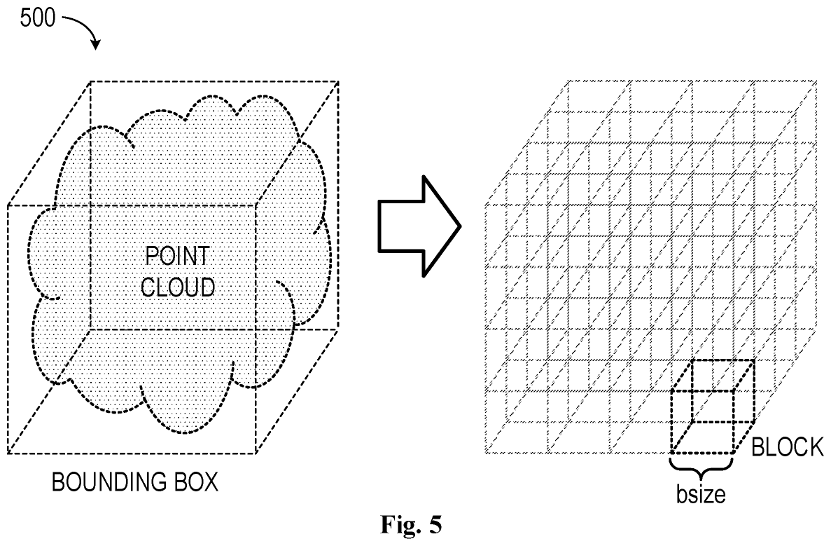

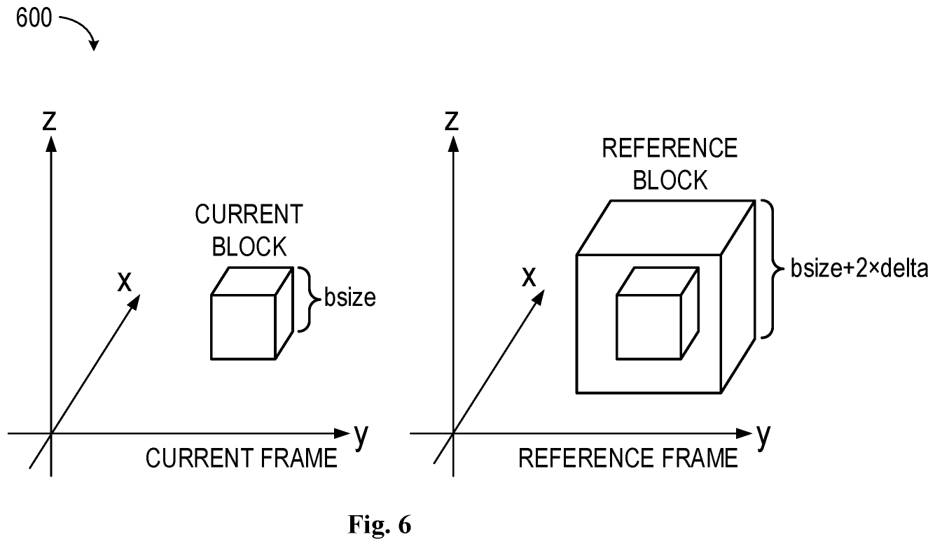

Secondly, scan block by block to derive the point array, pc_likely_world, which contains object points being used in the global motion estimation process. The scanning process takes the following steps:
1. The bounding box space of PC_{cur} is divided into multiple blocks, and the block size of each block is bsize*bsize*bsize. bsize is preset to 4096. FIG. 5 is a schematic diagram 500 illustrating an example of generation blocks for a point cloud.
2. For each block in the current frame, generate its corresponding reference block in the bounding box space of PC_{ref}. The reference block is the collocated block of current block with an extension in the reference frame and its block size is (bsize+2*delta)*(bsize+2*delta)*(bsize+2*delta). delta is preset to 1000. FIG. 6 is a schematic diagram 600 illustrating an example of generation reference blocks for current block.
3. For each block, traverse all the points in the current frame and record the points which is in the current block in an array, current_block. Move to step 4.
4. Traverse all the points in the reference frame and count the number of points which is in its corresponding reference block. If the number is zero, return to step 3 and scan next block. Otherwise, move to step 5.
5. For each point in the current_block, if its height value fits any one of the following conditions, it will be added to pc_likely_world. Return to step 3 and scan next block.
   (1) The height of the point is smaller than lower_bottom_thr.
   (2) The height of the point is greater than higher_top_thr.
   (3) The height of the point is between lower_top_thr and higher_top_thr, and the max height difference between the point and its neighbors (the point and its neighbors should belong to the same block) is higher than height_change_thr.
   (4) The height of the point is between lower_bottom_thr and higher_bottom_thr, and the max height difference between the point and its neighbors (the point and its neighbors should belong to the same block) is higher than height_change_thr.
2) This embodiment describes an example of how to classify a point cloud frame into object points and road points by using a point by point scanning process. The space unit is block in this example.

In the example, the input is the current frame, PC_{cur} and the reference frame, PC_{ref}. The output is the point array, pc_likely_world, which contains the object points that are used for global estimation.

Firstly, generate the two thresholds for road/object classification:
1. Obtain the histogram for the values of the points in PC_{cur} with the height being in the range of (B, T) with a specific histogram bin size. Where B is preset to −4000 and T is preset to −500. The values of B and T depend on the parameters of the point cloud acquisition device
2. Calculate the standard deviation (std) of the histogram.
3. Find the peak bin (P) of the histogram where the number of points achieve the maximum.
4. The thresholds are calculated as follows:

top_thr=P+1.5*std bottom_thr=P−1.5*std

Secondly, scan point by point to derive the point array, pc_likely_world, which contains object points being used in the global motion estimation process. The scanning process takes the following steps:
1. Count the number of blocks in the current frame, blocknum:

Bnum=maxBB_Scalled/bsize

blocknum=Bnum*Bnum*Bnum
maxBB_Scalled is the maximum side length of bounding box of PC_{cur}. bsize is the side length of a block, which is preset to 4096.
2. A bool array is generated to indicate the occupancy information of each reference block in PC_{ref}, ref_block_xyz. It is resized to blocknum.
3. For each point (x, y, z) in PC_{ref}, calculate the indexes of its corresponding reference blocks.

$${ID}_{0} = ( \frac{x + delta}{bsize} * Bnum + \frac{y + delta}{bsize} ) * Bnum + \frac{z + delta}{bsize} \\ {ID}_{1} = ( \frac{x + delta}{bsize} * Bnum + \frac{y + delta}{bsize} ) * Bnum + \frac{z - delta}{bsize} \\ {ID}_{2} = ( \frac{x + delta}{bsize} * Bnum + \frac{y - delta}{bsize} ) * Bnum + \frac{z + delta}{bsize} \\ {ID}_{3} = ( \frac{x + delta}{bsize} * Bnum + \frac{y - delta}{bsize} ) * Bnum + \frac{z - delta}{bsize} \\ {ID}_{4} = ( \frac{x - delta}{bsize} * Bnum + \frac{y + delta}{bsize} ) * Bnum + \frac{z + delta}{bsize} \\ {ID}_{5} = ( \frac{x - delta}{bsize} * Bnum + \frac{y + delta}{bsize} ) * Bnum + \frac{z - delta}{bsize} \\ {ID}_{6} = ( \frac{x - delta}{bsize} * Bnum + \frac{y - delta}{bsize} ) * Bnum + \frac{z + delta}{bsize} \\ {ID}_{7} = ( \frac{x - delta}{bsize} * Bnum + \frac{y - delta}{bsize} ) * Bnum + \frac{z - delta}{bsize}$$

delta is preset to 1000. In ref_block_xyz, the elements with these indexes are marked as occupied.
4. For each point (x,y,z) in PC_{cur}, calculate the index of its corresponding reference block:

$$ID = ( \frac{x}{bsize} * Bnum + \frac{y}{bsize} ) * Bnum + \frac{z}{bsize}$$

If the element corresponding with the index was not found in ref_block_xyz or was not marked as occupied, scan next point.
5. If the height value of the point fits any one of the following conditions, it will be added to pc_likely_world:
   (1) The height of the point is smaller than bottom_thr.
   (2) The height of the point is greater than top_thr.
3) This embodiment describes an example of how to classify a point cloud frame into object points and road points by using a planar region based scanning process.

In the example, the input is the current frame, PC_{cur} and the reference frame, PC_{ref}. The output is the point array, pc_likely_world, which contains the object points that are used for global estimation.

Firstly, generate the two thresholds for road/object classification:
1. Obtain the histogram for the values of the points in PC_{cur} with the height being in the range of (B, T) with a specific histogram bin size. Where B is preset to −4000 and T is preset to −500. The values of B and T depend on the parameters of the point cloud acquisition device
2. Calculate the standard deviation (std) of the histogram.
3. Find the peak bin (P) of the histogram where the number of points achieve the maximum.
4. The thresholds are calculated as follows:

top_thr=P+1*std

bottom_thr=P−1*std

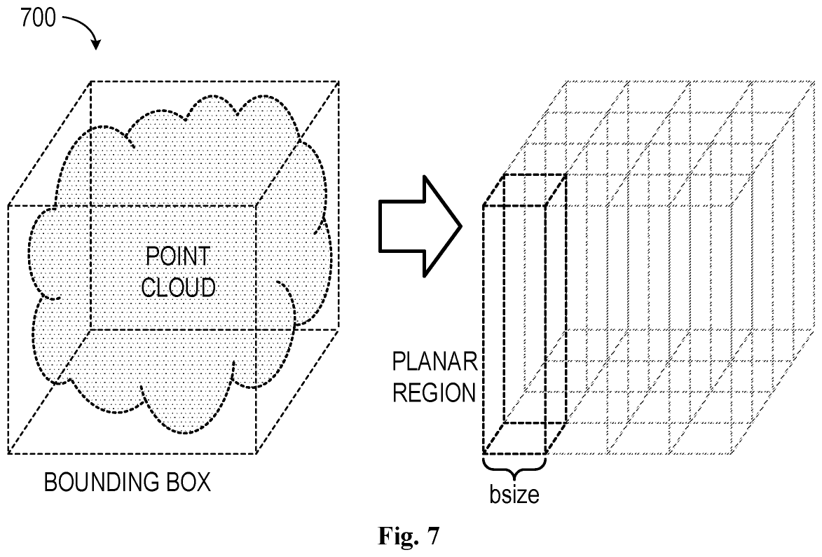

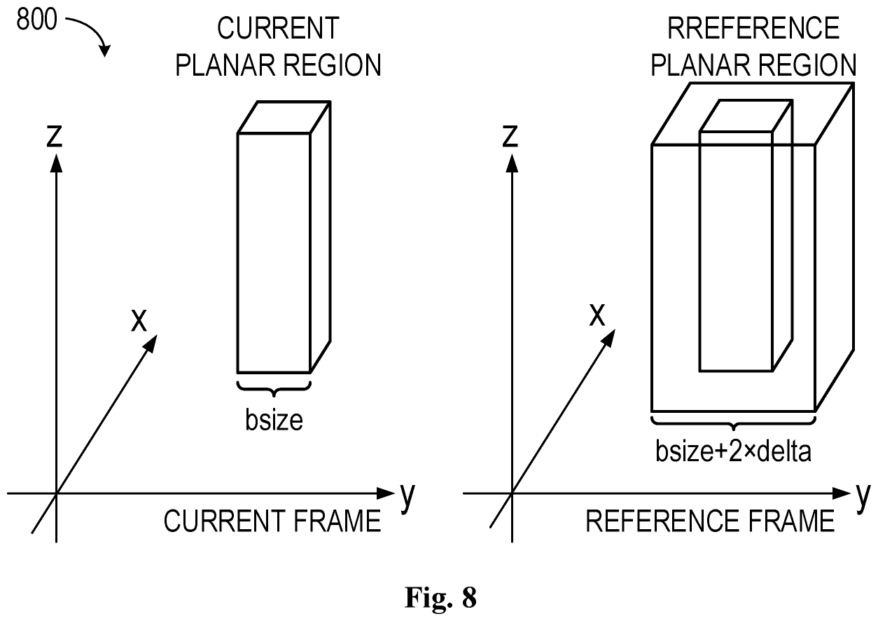

Secondly, scan each planar region to derive the point array, pc_likely_world, which contains object points being used in the global motion estimation process. The scanning process takes the following steps:
1. The bounding box space of PC_{cur} is divided into multiple planar regions, and the region size of each block is bsize*bsize. bsize is preset to 4096. FIG. 7 is a schematic diagram 700 illustrating an example of generation planar regions for a point cloud.
2. For each planar region in the current frame, generate its corresponding reference planar region in the bounding box space of PC_{ref}. The reference planar region is the collocated planar region of current planar region with an extension in the reference frame and its region size is (bsize+2*delta)*(bsize+2*delta). delta is preset to 1000. FIG. 8 is a schematic diagram 800 illustrating an example of generation reference planar regions for current planar region
3. For each planar region, traverse all the points in the current frame and record the points which is in the current planar region in an array, current_region.
4. Traverse all the points in the reference frame and count the number of points which is in its corresponding reference planar region. If the number is zero, scan next planar region.
5. For each point in the current_region, if its height value fits any one of the following conditions, it will be added to pc_likely_world:
   (1) The height of the point is smaller than lower_bottom_thr.
   (2) The height of the point is greater than higher_top_thr.
4) This embodiment describes an example of how to classify a point cloud frame into object points and road points by using a point by point scanning process. The space unit is planar region in this example.

In the example, the input is the current frame, PC_{cur} and the reference frame, PC_{ref}. The output is the point array, pc_likely_world, which contains the object points that are used for global estimation.

Firstly, generate the two thresholds for road/object classification:
1. Obtain the histogram for the values of the points in PC_{cur} with the height being in the range of (B, T) with a specific histogram bin size. Where B is preset to −4000 and T is preset to −500. The values of B and T depend on the parameters of the point cloud acquisition device
2. Calculate the standard deviation (std) of the histogram.
3. Find the peak bin (P) of the histogram where the number of points achieve the maximum.
4. The thresholds are calculated as follows:

top_thr=P+1.5*std

bottom_thr=P−1.5*std

Secondly, scan point by point to derive the point array, pc_likely_world, which contains object points being used in the global motion estimation process. The scanning process takes the following steps:
1. Count the number of planar regions in the current frame, Region_num:

Rnum=maxBB_Scalled/bsize

Region_num=Rnum*Rnum
maxBB_Scalled is the maximum side length of bounding box of PC_{cur}. bsize is the side length of a planar region, which is preset to 4096.
2. A bool array is generated to indicate the occupancy information of each reference planar region in PC_{ref}, ref_planar_region. It is resized to Region_num.
3. For each point (x, y, z) in PC_{ref}, calculate the indexes of its corresponding reference planar regions.

$${ID}_{0} = \frac{x + delta}{bsize} * Rnum + \frac{y + delta}{bsize} \\ {ID}_{1} = \frac{x + delta}{bsize} * Rnum + \frac{y - delta}{bsize} \\ {ID}_{2} = \frac{x - delta}{bsize} * Rnum + \frac{y + delta}{bsize} \\ {ID}_{3} = \frac{x - delta}{bsize} * Rnum + \frac{y - delta}{bsize}$$

delta is preset to 1000. In ref_planar_region, the elements with these indexes are marked as occupied.
4. For each point (x, y, z) in PC_{cur}, calculate the index of its corresponding reference planar region:

$$ID = \frac{x}{bsize} * Rnum + \frac{y}{bsize}$$

If the element corresponding with the index was not found in ref_planar_region or was not marked as occupied, scan next point.
5. If the height value of the point fits any one of the following conditions, it will be added to pc_likely_world:
   (1) The height of the point is smaller than bottom_thr.
   (2) The height of the point is greater than top_thr.

The embodiments of the present disclosure are related to classification-based global motion estimation methods for point cloud coding. As used herein, the term “point cloud sequence” may refer to a sequence of one or more point clouds. The term “frame” may refer to a point cloud in a point cloud sequence.

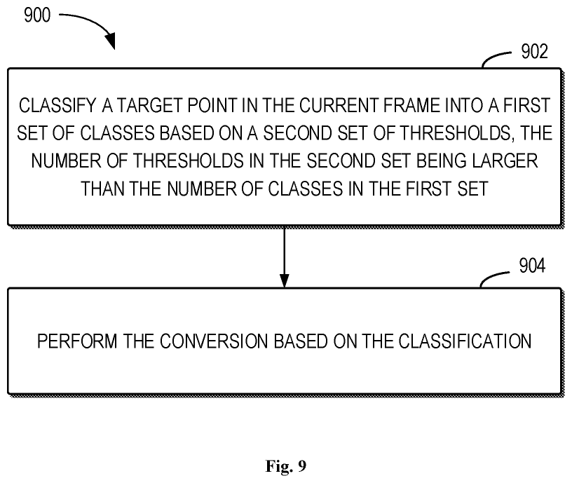

FIG. 9 illustrates a flowchart of a method 900 for point cloud coding in accordance with some embodiments of the present disclosure. The method 900 may be implemented during a conversion between a current frame of a point cloud sequence and a bitstream of the point cloud sequence. As shown in FIG. 9, the method 900 starts at 902, where a target point in the current frame is classified into a first set of classes based on a second set of thresholds. The number of thresholds in the second set is larger than the number of classes in the first set. By way of example, the number of thresholds in the second set may be 5, and the number of classes in the first set may be 2.

In some examples, the second set of thresholds may comprise a first threshold, a second threshold, a third threshold, a fourth threshold and a fifth threshold. The first threshold may be larger than or equal to the second threshold. The second threshold may be larger than or equal to the third threshold. The third threshold may be larger than or equal to the fourth threshold. The first set of classes may comprise a first class associated with object points and a second class associated with road points.

For instance, the target point may be classified into the first class, if a height of the target point is smaller than the fourth threshold or larger than the first threshold. In another example, the target point may be classified into the second class, if the height of the target point is smaller than the second threshold and larger than the third threshold. Additionally or alternatively, the target point may be classified into the first class, if the height of the target point is smaller than or equal to the first threshold and larger than or equal to the second threshold, and the max height difference between the target point and points neighboring to the target point is larger than the fifth threshold.

In some additional or alternative embodiments, the target point may be classified into the first class, if the height of the target point is smaller than or equal to the third threshold and larger than or equal to the fourth threshold, and the max height difference between the target point and points neighboring to the target point is larger than the fifth threshold.

The target point may be, additionally or alternatively, classified into the second class, if the height of the target point is smaller than or equal to the first threshold and larger than or equal to the second threshold, and the max height difference between the target point and points neighboring to the target point is smaller than or equal to the fifth threshold.

As a further additional or alternative example, the target point may be classified into the second class, if the height of the target point is smaller than or equal to the third threshold and larger than or equal to the fourth threshold, and the max height difference between the target point and points neighboring to the target point is smaller than or equal to the fifth threshold.

It should be understood that the above illustrations and/or examples are described merely for purpose of description. The scope of the present disclosure is not limited in this respect.

At 904, the conversion is performed based on the classification. In some embodiments the conversion may include encoding the current frame into the bitstream. Alternatively or additionally, the conversion may include decoding the current frame from the bitstream.

The method 900 increases the number of thresholds used for classifying a point in the frame. Compared with the conventional solution where the number of thresholds is equal to the number of classes, the proposed method can advantageously enable more accurate classification of the points, and thus improve the accuracy of global motion estimation and coding quality.

In some embodiments, at least one threshold in the second set may be predefined. Alternatively, at least one threshold in the second set may be determined based on heights of points in the point cloud sequence.

In some embodiments, a value of at least one threshold in the second set may be different from a value of the at least one threshold used for a further point in the point cloud sequence. For example, a value of the above mentioned first threshold may be 5 for the current frame, while the value of the above mentioned first threshold may be 4 for a frame following the current frame. It should be understood that the above illustrations and/or examples are described merely for purpose of description. The scope of the present disclosure is not limited in this respect.

In some embodiments, at least one threshold in the second set may be indicated in the bitstream. For example, the above mentioned first threshold may be signaled from the encoder to the decoder.

In some embodiments, at least one threshold in the second set may be generated at an encoder. Additionally or alternatively, at least one threshold in the second set may be generated at a decoder.

In some embodiments, at least one threshold in the second set may be generated based on at least one of the current frame or a further frame of the point cloud sequence. In one example, the further frame may comprise a reference frame of the current frame. Additionally or alternatively, an indication of the further frame may be indicated in the bitstream. In another example, the further frame may be predefined. In yet another example, the further frame may comprise a reference frame with a reference frame index may be equal to 0. It should be understood that the term “reference frame index” may also be referred to as reference picture index. The scope of the present disclosure is not limited in this respect.

In some embodiments, at least one threshold in the second set may be generated based on a histogram of geometry features of points in the point cloud sequence. By way of example, the histogram may be generated with a specific histogram bin size based at least on a part of points in the current frame. Alternatively, the histogram may be generated based at least on a part of previously coded points. In one example, whether a point in the point cloud sequence may be used to generate the histogram may be dependent on a characteristic of the point. For example, the point may be used to generate the histogram, if a height value of the point may be within a preset range. In one example, the at least one threshold may be generated based on a standard deviation of the histogram. It should be understood that the above illustrations and/or examples are described merely for purpose of description. The scope of the present disclosure is not limited in this respect.

In some embodiments, at least one threshold in the second set may be processed before may be used. By way example, a threshold may be set to a predefined value, if it exceeds a preset upper limit. It should be understood that the above illustrations and/or examples are described merely for purpose of description. The scope of the present disclosure is not limited in this respect.

In some embodiments, at 902, a geography value or a feature value of the target point and at least one threshold in the second set may be compared. The target point may be classified based on the comparison.

In some embodiments, at 902, a target difference and at least one threshold in the second set may be compared. The target difference indicates a geography value difference or a feature value difference between the target point and at least one point neighboring to the target point. The target point may be classified based on the comparison.

In some embodiments, a bitstream of a point cloud sequence may be stored in a non-transitory computer-readable recording medium. The bitstream of the point cloud sequence can be generated by a method performed by a point cloud processing apparatus. According to the method, a target point in the current frame is classified into a first set of classes based on a second set of thresholds. The number of thresholds in the second set is larger than the number of classes in the first set. A bitstream of the current frame may be generated based on the classification.

In some embodiments, a target point in the current frame is classified into a first set of classes based on a second set of thresholds. The number of thresholds in the second set is larger than the number of classes in the first set. A bitstream of the current frame may be generated based on the classification. The bitstream may be stored in a non-transitory computer-readable recording medium.

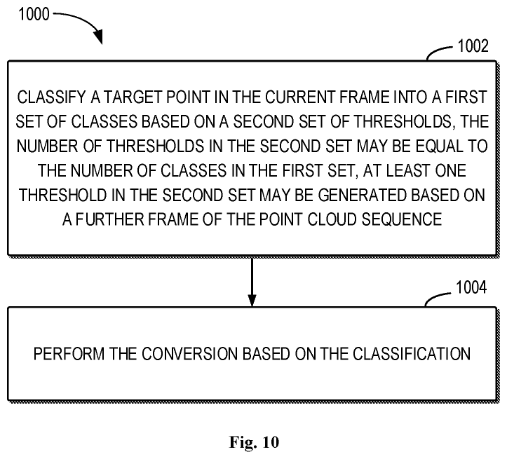

FIG. 10 illustrates a flowchart of another method 1000 for point cloud coding in accordance with some embodiments of the present disclosure. The method 1000 may be implemented during a conversion between a current frame of a point cloud sequence and a bitstream of the point cloud sequence. As shown in FIG. 10, the method 1000 starts at 1002, where a target point in the current frame is classified into a first set of classes based on a second set of thresholds. The number of thresholds in the second set is equal to the number of classes in the first set. At least one threshold in the second set is generated based on a further frame of the point cloud sequence.

By way of example, the further frame may comprise a reference frame of the current frame. A threshold in the second set may be generated based on a histogram of geometry features of points in the current frame and a reference frame of the current frame. It should be understood that the above illustrations and/or examples are described merely for purpose of description. The scope of the present disclosure is not limited in this respect.

At 1004, the conversion is performed based on the classification. In some embodiments the conversion may include encoding the current frame into the bitstream. Alternatively or additionally, the conversion may include decoding the current frame from the bitstream.

According to the method 1000, in addition to the current frame, a further frame of the point cloud sequence is also used to generate the threshold used for classifying a point. Compared with the conventional solution where only the current frame is used to generate the threshold, the proposed method can advantageously generate more reasonable thresholds which enable more accurate classification of the points, and thus improve the accuracy of global motion estimation and coding quality.

In some embodiments, an indication of the further frame may be indicated in the bitstream. Alternatively, the further frame may be predefined. In one example, the further frame may comprise a reference frame with a reference frame index may be equal to 0.

In some embodiments, a bitstream of a point cloud sequence may be stored in a non-transitory computer-readable recording medium. The bitstream of the point cloud sequence can be generated by a method performed by a point cloud processing apparatus. According to the method, a target point in the current frame is classified into a first set of classes based on a second set of thresholds. The number of thresholds in the second set is equal to the number of classes in the first set. At least one threshold in the second set is generated based on a further frame of the point cloud sequence. A bitstream of the current frame may be generated based on the classification.

In some embodiments, a target point in the current frame is classified into a first set of classes based on a second set of thresholds. The number of thresholds in the second set is equal to the number of classes in the first set. At least one threshold in the second set is generated based on a further frame of the point cloud sequence. A bitstream of the current frame may be generated based on the classification. The bitstream may be stored in a non-transitory computer-readable recording medium.

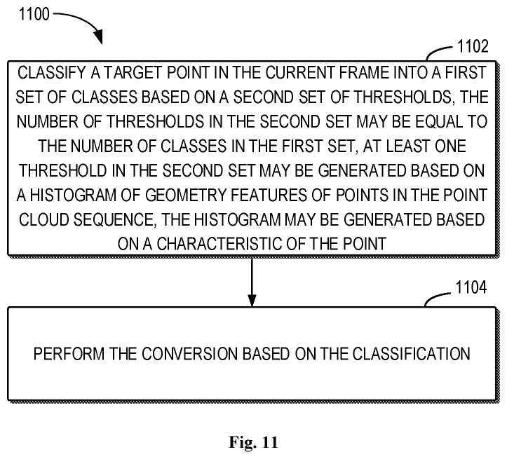

FIG. 11 illustrates a flowchart of another method 1100 for point cloud coding in accordance with some embodiments of the present disclosure. The method 1100 may be implemented during a conversion between a current frame of a point cloud sequence and a bitstream of the point cloud sequence. As shown in FIG. 11, the method 1100 starts at 1102, where a target point in the current frame is classified into a first set of classes based on a second set of thresholds. The number of thresholds in the second set is equal to the number of classes in the first set. At least one threshold in the second set is generated based on a histogram of geometry features of points in the point cloud sequence. The histogram is generated based on a characteristic of the point. By way of example, a point in the point cloud sequence may be used to generate the histogram, if a height value of the point may be within a preset range. It should be understood that the above illustrations and/or examples are described merely for purpose of description. The scope of the present disclosure is not limited in this respect.

At 1104, the conversion is performed based on the classification. In some embodiments the conversion may include encoding the current frame into the bitstream. Alternatively or additionally, the conversion may include decoding the current frame from the bitstream.

According to the method 1100, the characteristic of points to be used for generating the histogram of geometry features of points is taken into consideration. Compared with the conventional solution, the proposed method can advantageously generate more reasonable thresholds which enable more accurate classification of the points, and thus improve the accuracy of global motion estimation and coding quality.

In some embodiments, a bitstream of a point cloud sequence may be stored in a non-transitory computer-readable recording medium. The bitstream of the point cloud sequence can be generated by a method performed by a point cloud processing apparatus. According to the method, a target point in the current frame is classified into a first set of classes based on a second set of thresholds. The number of thresholds in the second set is equal to the number of classes in the first set. At least one threshold in the second set is generated based on a histogram of geometry features of points in the point cloud sequence. The histogram is generated based on a characteristic of the point. A bitstream of the current frame may be generated based on the classification.

In some embodiments, a target point in the current frame is classified into a first set of classes based on a second set of thresholds. The number of thresholds in the second set is equal to the number of classes in the first set. At least one threshold in the second set is generated based on a histogram of geometry features of points in the point cloud sequence. The histogram is generated based on a characteristic of the point. A bitstream of the current frame may be generated based on the classification. The bitstream may be stored in a non-transitory computer-readable recording medium.

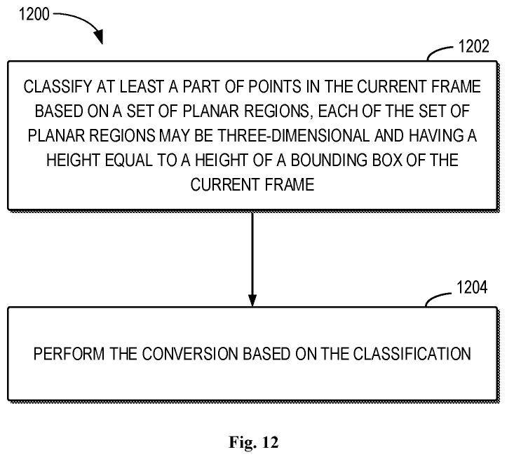

FIG. 12 illustrates a flowchart of another method 1200 for point cloud coding in accordance with some embodiments of the present disclosure. The method 1200 may be implemented during a conversion between a current frame of a point cloud sequence and a bitstream of the point cloud sequence. As shown in FIG. 12, the method 1200 starts at 1202, where at least a part of points in the current frame are classified based on a set of planar regions. Each of the set of planar regions may be three-dimensional and have a height equal to a height of a bounding box of the current frame.

By way of example, each of the set of planar regions may be cuboid. With reference to FIG. 4, the cuboid 410 may corresponds to a planar region. Each point in the current frame may be assigned to one of the set of planar regions based on coordinates of the point. The point may be classified based on the assignment. It should be understood that the possible implementation of the planar region shown in FIG. 4 is merely illustrative and therefore should not be construed as limiting the present disclosure in any way.

At 1204, the conversion is performed based on the classification. In some embodiments the conversion may include encoding the current frame into the bitstream. Alternatively or additionally, the conversion may include decoding the current frame from the bitstream.

The method 1200 utilizes planar regions as process units to perform the classification process. Compared with the conventional solution where a block is used, the proposed method can advantageously reduce the number of iterations in the classification process and thus reduce the complexity of classification process and improve the coding efficiency.

In some embodiments, a reference frame of the current frame may comprise at least one reference planar regions, and a reference point in the reference frame belongs to at least one reference planar regions.

In some embodiments, for a planar region in the current frame, a reference frame of the current frame may comprise a reference planar region corresponding to the planar region. Alternatively, the reference frame of the current frame may not comprise a reference planar region corresponding to the planar region.

In some embodiments, whether a point in a planar region is to be classified may be dependent on a reference planar region in a reference frame of the current frame. The reference planar region corresponds to the planar region. For example, the point may be classified, if at least one reference points belong to the reference planar region. In some embodiments, how to classify a point in a planar region may be dependent on a classification condition.

In some embodiments, the part of points may be classified into a first set of classes based on a plurality of thresholds. In one example, the first set of classes may comprise a first class associated with object points and a second class associated with road points.

In some embodiments, at 902, 1002 or 1102, the target point may be assigned to one of a plurality of space units for a global motion estimation process of the current frame. The target point may be classified based on the assignment. In some embodiments, a reference frame of the current frame may comprise at least one reference space units, and a reference point in the reference frame may belong to at least one reference space units. In one example, the at least one reference space units may be at least one reference blocks or at least one planar regions.

In some embodiments, the method 900, 1000 or 1100 may further comprise: assigning a reference point of the target point to the at least one reference space units, the reference point may be in the reference frame, and marking a reference space unit if a reference point may be assigned to the reference space unit. In one example, for a space unit in the current frame, a reference frame of the current frame may comprise a reference space unit corresponding to the space unit. Alternatively, the reference frame of the current frame may not comprise a reference space unit corresponding to the space unit

In some embodiments, at 904, 1004, or 1104, at least a part of points in the current frame may be classified into the first set of classes. Whether a point in a space unit may be to be classified may be dependent on a reference space unit in a reference frame of the current frame. The reference space unit corresponds to the space unit. The conversion may be performed based on the classification. In one example, the point may be classified, if at least one reference points belong to the reference space unit. In some embodiments, 45. how to classify a point in a space unit may be dependent on a classification condition.

In some embodiments, the first set of classes may comprise a first class associated with object points and a second class associated with road points. The part of points may be classified into the first class or the second class based on a plurality of thresholds.

In some embodiments, at 904, 1004, 1104, or 1204, global motion information for the current frame may be determined based on the classification. The conversion may be performed based on the global motion information. For example, the global motion information may comprise a global motion matrix determined by a least mean square (LMS) algorithm with samples and reference samples. The samples may be determined based on points in the current frame. The reference samples may be determined based on reference points in a reference frame of the current frame.

In some embodiments, the global motion information may comprise a global motion matrix. A reference frame with motion compensation may be obtained by applying the global motion matrix to all of points in a reference frame of the current frame. The conversion may be performed based on the reference frame with motion compensation.

In some embodiments, a bitstream of a point cloud sequence may be stored in a non-transitory computer-readable recording medium. The bitstream of the point cloud sequence can be generated by a method performed by a point cloud processing apparatus. According to the method, at least a part of points in the current frame are classified based on a set of planar regions. Each of the set of planar regions may be three-dimensional and have a height equal to a height of a bounding box of the current frame. A bitstream of the current frame may be generated based on the classification.

In some embodiments, at least a part of points in the current frame are classified based on a set of planar regions. Each of the set of planar regions may be three-dimensional and have a height equal to a height of a bounding box of the current frame. A bitstream of the current frame may be generated based on the classification. The bitstream may be stored in a non-transitory computer-readable recording medium.

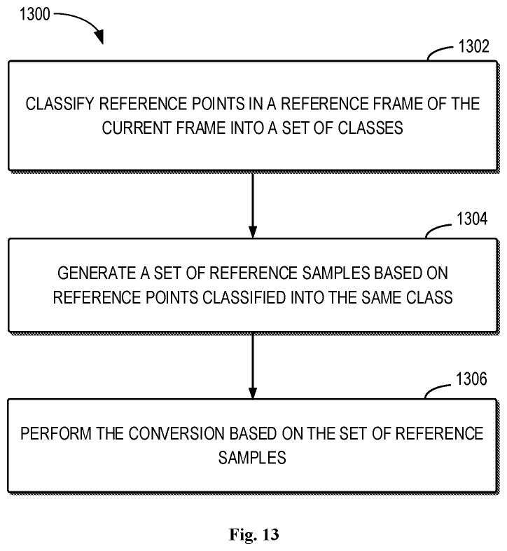

FIG. 13 illustrates a flowchart of another method 1300 for point cloud coding in accordance with some embodiments of the present disclosure. The method 1300 may be implemented during a conversion between a current frame of a point cloud sequence and a bitstream of the point cloud sequence. As shown in FIG. 13, the method 1300 starts at 1302, where reference points in a reference frame of the current frame are classified into a set of classes. By way of example, reference point may be classified into a set of classes based on two thresholds. The set of classes comprise a first class associated with object points and a second class associated with road points.

At 1304, a set of reference samples are generated based on reference points classified into the same class. By way of example, a reference sample may be generated based on a set of reference points classified into the first class. It should be understood that the above illustrations and/or examples are described merely for purpose of description. The scope of the present disclosure is not limited in this respect.

At 1306, the conversion is performed based on the set of reference samples. In some embodiments the conversion may include encoding the current frame into the bitstream. Alternatively or additionally, the conversion may include decoding the current frame from the bitstream.

According to the method 1300, reference samples are generated based on reference points classified into the same class. Thereby, the proposed method can advantageously avoid mismatching in global motion estimation, and thus improve the accuracy of global motion estimation and coding quality.

In some embodiments, the method 1300 may further comprise: classifying points in the current frame into the set of classes; and generating a set of samples by downsampling points classified into the same class.

In some embodiments, at 1306, global motion information may be generated based on the set of samples and the set of reference samples. The conversion may be performed based on the global motion information.

In some embodiments, a sample in the set of samples may be associated with a reference sample in the set of reference samples. The reference sample may be generated based on reference points classified into the same class as points for generating the sample. In some embodiments, the reference points may be classified based on a geography value or a feature value of the reference points. For example, the reference points may be classified based on a height of the reference points. In some embodiments, the points may be classified based on a geography value or a feature value of the points. For example, the points may be classified based on a height of the points.

In some embodiments, a reference point in the reference frame may be marked as a reference sample of a sample in the set samples, if the reference point has the least Euclidean distance from the sample among all of reference points in the reference frame.

In some embodiments, a bitstream of a point cloud sequence may be stored in a non-transitory computer-readable recording medium. The bitstream of the point cloud sequence can be generated by a method performed by a point cloud processing apparatus. According to the method, reference points in a reference frame of the current frame are classified into a set of classes. A set of reference samples are generated based on reference points classified into the same class. A bitstream of the current frame may be generated based on the set of reference samples.

In some embodiments, reference points in a reference frame of the current frame are classified into a set of classes. A set of reference samples are generated based on reference points classified into the same class. A bitstream of the current frame may be generated based on the set of reference samples. The bitstream may be stored in a non-transitory computer-readable recording medium.

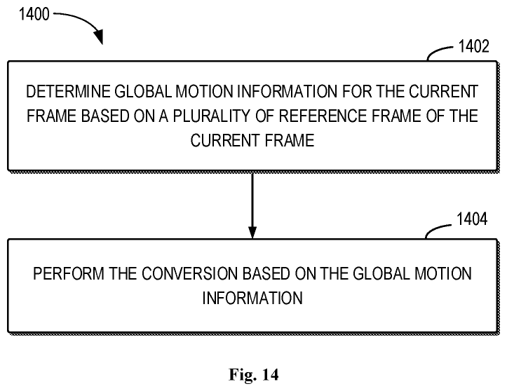

FIG. 14 illustrates a flowchart of another method 1400 for point cloud coding in accordance with some embodiments of the present disclosure. The method 1400 may be implemented during a conversion between a current frame of a point cloud sequence and a bitstream of the point cloud sequence. As shown in FIG. 14, the method 1400 starts at 1402, where global motion information for the current frame is determined based on a plurality of reference frame of the current frame. For example, the current frame may have on reference frame preceding the current frame and a reference frame following the current frame in a display order. The global motion estimation process may be performed with the two reference frames, so as to determined global motion information for the current frame. It should be understood that the above illustrations and/or examples are described merely for purpose of description. The scope of the present disclosure is not limited in this respect.

At 1404, the conversion is performed based on the global motion information. In some embodiments the conversion may include encoding the current frame into the bitstream. Alternatively or additionally, the conversion may include decoding the current frame from the bitstream.

According to the method 1400, the global motion estimation is performed on the frame with more than one reference frame. Compared with the conventional solution where only one reference frame is used, the proposed method can advantageously improve the accuracy of global motion estimation and coding quality.

In some embodiments, at 1402, at least a part of points in the current frame may be classified based on a set of planar regions. Each of the set of planar regions may be three-dimensional and have a height equal to a height of a bounding box of the current frame. By way of example, each of the set of planar regions may be cuboid. With reference to FIG. 4, the cuboid 410 may corresponds to a planar region. The global motion information may be determined based on the classification. It should be understood that the possible implementation of the planar region shown in FIG. 4 is merely illustrative and therefore should not be construed as limiting the present disclosure in any way.

In some embodiments, at 1402, a target point in the current frame may be assigned to one of a plurality of space units for a global motion estimation process of the current frame. The target point may be classified into a set of classes and the global motion information may be determined based on the classification.

In some embodiments, a bitstream of a point cloud sequence may be stored in a non-transitory computer-readable recording medium. The bitstream of the point cloud sequence can be generated by a method performed by a point cloud processing apparatus. According to the method, global motion information for the current frame is determined based on a plurality of reference frame of the current frame. A bitstream of the current frame may be generated based on the global motion information.

In some embodiments, global motion information for the current frame is determined based on a plurality of reference frame of the current frame. A bitstream of the current frame may be generated based on the global motion information. The bitstream may be stored in a non-transitory computer-readable recording medium.

Implementations of the present disclosure can be described in view of the following clauses, the features of which can be combined in any reasonable manner.
Clause 1. A method for point cloud coding, comprising: classifying, during a conversion between a current frame of a point cloud sequence and a bitstream of the point cloud sequence, a target point in the current frame into a first set of classes based on a second set of thresholds, the number of thresholds in the second set being larger than the number of classes in the first set; and performing the conversion based on the classification.
Clause 2. The method of clause 1, wherein the number of thresholds in the second set is 5, and the number of classes in the first set is 2.
Clause 3. The method of clause 2, wherein the second set of thresholds comprise a first threshold, a second threshold, a third threshold, a fourth threshold and a fifth threshold, the first threshold being larger than or equal to the second threshold, the second threshold being larger than or equal to the third threshold, the third threshold being larger than or equal to the fourth threshold, the first set of classes comprise a first class associated with object points and a second class associated with road points, and classifying the target point comprises at least one of: classifying the target point into the first class, if a height of the target point is smaller than the fourth threshold or larger than the first threshold, classifying the target point into the second class, if the height of the target point is smaller than the second threshold and larger than the third threshold, classifying the target point into the first class, if the height of the target point is smaller than or equal to the first threshold and larger than or equal to the second threshold and the max height difference between the target point and points neighboring to the target point is larger than the fifth threshold, classifying the target point into the first class, if the height of the target point is smaller than or equal to the third threshold and larger than or equal to the fourth threshold and the max height difference between the target point and points neighboring to the target point is larger than the fifth threshold, classifying the target point into the second class, if the height of the target point is smaller than or equal to the first threshold and larger than or equal to the second threshold and the max height difference between the target point and points neighboring to the target point is smaller than or equal to the fifth threshold, or classifying the target point into the second class, if the height of the target point is smaller than or equal to the third threshold and larger than or equal to the fourth threshold and the max height difference between the target point and points neighboring to the target point is smaller than or equal to the fifth threshold.
Clause 4. The method of any of clauses 1-3, wherein at least one threshold in the second set is predefined.
Clause 5. The method of any of clauses 1-3, wherein at least one threshold in the second set is determined based on heights of points in the point cloud sequence.
Clause 6. The method of any of clauses 1-5, wherein a value of at least one threshold in the second set is different from a value of the at least one threshold used for a further point in the point cloud sequence.
Clause 7. The method of any of clauses 1-6, wherein at least one threshold in the second set is indicated in the bitstream.
Clause 8. The method of any of clauses 1-7, wherein at least one threshold in the second set is generated at an encoder.
Clause 9. The method of any of clauses 1-6, wherein at least one threshold in the second set is generated at a decoder.
Clause 10. The method of any of clauses 1-3, wherein at least one threshold in the second set is generated based on at least one of the current frame or a further frame of the point cloud sequence.
Clause 11. The method of clause 10, wherein the further frame comprises a reference frame of the current frame.
Clause 12. The method of any of clauses 10-11, wherein an indication of the further frame is indicated in the bitstream.
Clause 13. The method of clause 10, wherein the further frame is predefined.
Clause 14. The method of clause 13, wherein the further frame comprises a reference frame with a reference frame index being equal to 0.
Clause 15. The method of any of clauses 1-3, wherein at least one threshold in the second set is generated based on a histogram of geometry features of points in the point cloud sequence.
Clause 16. The method of clause 15, wherein the histogram is generated with a specific histogram bin size based at least on a part of points in the current frame, or the histogram is generated based at least on a part of previously coded points.
Clause 17. The method of any of clauses 15-16, wherein whether a point in the point cloud sequence is used to generate the histogram is dependent on a characteristic of the point.
Clause 18. The method of clause 17, wherein the point is used to generate the histogram, if a height value of the point is within a preset range.
Clause 19. The method of any of clauses 15-18, wherein the at least one threshold is generated based on a standard deviation of the histogram.
Clause 20. The method of any of clauses 1-20, wherein at least one threshold in the second set is processed before being used.
Clause 21. The method of any of clauses 1-2, wherein classifying the target point comprises: comparing a geography value or a feature value of the target point and at least one threshold in the second set; and classifying the target point based on the comparison.
Clause 22. The method of any of clauses 1-2, wherein classifying the target point comprises: comparing a target difference and at least one threshold in the second set, the target difference indicating a geography value difference or a feature value difference between the target point and at least one point neighboring to the target point; and classifying the target point based on the comparison.
Clause 23. A method for point cloud coding, comprising: classifying, during a conversion between a current frame of a point cloud sequence and a bitstream of the point cloud sequence, a target point in the current frame into a first set of classes based on a second set of thresholds, the number of thresholds in the second set being equal to the number of classes in the first set, at least one threshold in the second set is generated based on a further frame of the point cloud sequence; and performing the conversion based on the classification.
Clause 24. The method of clause 23, wherein the further frame comprises a reference frame of the current frame.
Clause 25. The method of any of clauses 23-24, wherein an indication of the further frame is indicated in the bitstream.
Clause 26. The method of clause 23, wherein the further frame is predefined.
Clause 27. The method of clause 26, wherein the further frame comprises a reference frame with a reference frame index being equal to 0.
Clause 28. A method for point cloud coding, comprising: classifying, during a conversion between a current frame of a point cloud sequence and a bitstream of the point cloud sequence, a target point in the current frame into a first set of classes based on a second set of thresholds, the number of thresholds in the second set being equal to the number of classes in the first set, at least one threshold in the second set being generated based on a histogram of geometry features of points in the point cloud sequence, the histogram being generated based on a characteristic of the point; and performing the conversion based on the classification.
Clause 29. The method of clause 28, wherein a point in the point cloud sequence is used to generate the histogram, if a height value of the point is within a preset range.
Clause 30. A method for point cloud coding, comprising: classifying, during a conversion between a current frame of a point cloud sequence and a bitstream of the point cloud sequence, at least a part of points in the current frame based on a set of planar regions, each of the set of planar regions being three-dimensional and having a height equal to a height of a bounding box of the current frame; and performing the conversion based on the classification.
Clause 31. The method of clause 30, wherein each of the set of planar regions is cuboid, and each point in the current frame is assigned to one of the set of planar regions based on coordinates of the point.
Clause 32. The method of any of clauses 30-31, wherein a reference frame of the current frame comprises at least one reference planar regions, and a reference point in the reference frame belongs to at least one reference planar regions.
Clause 33. The method of any of clauses 30-32, wherein, for a planar region in the current frame, a reference frame of the current frame comprises or does not comprise a reference planar region corresponding to the planar region.
Clause 34. The method of any of clauses 30-33, wherein whether a point in a planar region is to be classified is dependent on a reference planar region in a reference frame of the current frame, the reference planar region corresponding to the planar region.
Clause 35. The method of clause 34, wherein the point is classified, if at least one reference points belong to the reference planar region.
Clause 36. The method of any of clauses 30-35, wherein how to classify a point in a planar region is dependent on a classification condition.
Clause 37. The method of any of clauses 30-35, wherein the part of points is classified into a first set of classes based on a plurality of thresholds, the first set of classes comprising a first class associated with object points and a second class associated with road points.
Clause 38. The method of any of clauses 1-29, wherein classifying the target point comprises: assigning the target point to one of a plurality of space units for a global motion estimation process of the current frame; and classifying the target point based on the assignment.
Clause 39. The method of clause 38, wherein a reference frame of the current frame comprises at least one reference space units, and a reference point in the reference frame belongs to at least one reference space units.
Clause 40. The method of clause 39, wherein the at least one reference space units is at least one reference blocks or at least one planar regions, each of at least one planar regions being three-dimensional and having a height equal to a height of a bounding box of the current frame.
Clause 41. The method of any of clauses 39-40, further comprising: assigning a reference point of the target point to the at least one reference space units, the reference point being in the reference frame, and marking a reference space unit if a reference point is assigned to the reference space unit.
Clause 42. The method of any of clauses 38-41, wherein, for a space unit in the current frame, a reference frame of the current frame comprises or does not comprise a reference space unit corresponding to the space unit.
Clause 43. The method of any of clauses 38-42, performing the conversion comprises: classifying at least a part of points in the current frame into the first set of classes, whether a point in a space unit is to be classified being dependent on a reference space unit in a reference frame of the current frame, the reference space unit corresponding to the space unit; and performing the conversion based on the classification.
Clause 44. The method of clause 43, wherein the point is classified, if at least one reference points belong to the reference space unit.
Clause 45. The method of any of clauses 43-44, wherein how to classify a point in a space unit is dependent on a classification condition.
Clause 46. The method of any of clauses 43-44, wherein the first set of classes comprise a first class associated with object points and a second class associated with road points, and the part of points is classified into the first class or the second class based on a plurality of thresholds.
Clause 47. The method of any of clauses 1-46, wherein performing the conversion based on the classification comprises: determining global motion information for the current frame based on the classification; and performing the conversion based on the global motion information.
Clause 48. The method of clause 47, wherein the global motion information comprises a global motion matrix determined by a least mean square (LMS) algorithm with samples and reference samples, the samples being determined based on points in the current frame, the reference samples being determined based on reference points in a reference frame of the current frame.
Clause 49. The method of clause 47, wherein the global motion information comprises a global motion matrix, and performing the conversion based on the global motion information comprises: obtaining a reference frame with motion compensation by applying the global motion matrix to all of points in a reference frame of the current frame; and performing the conversion based on the reference frame with motion compensation.
Clause 50. A method for point cloud coding, comprising: classifying, during a conversion between a current frame of a point cloud sequence and a bitstream of the point cloud sequence, reference points in a reference frame of the current frame into a set of classes; generating a set of reference samples based on reference points classified into the same class; and performing the conversion based on the set of reference samples.
Clause 51. The method of clause 50, further comprising: classifying points in the current frame into the set of classes; and generating a set of samples by downsampling points classified into the same class.
Clause 52. The method of clause 51, wherein performing the conversion comprises: generating global motion information based on the set of samples and the set of reference samples; and performing the conversion based on the global motion information.
Clause 53. The method of any of clauses 51-52, wherein a sample in the set of samples is associated with a reference sample in the set of reference samples, the reference sample being generated based on reference points classified into the same class as points for generating the sample.
Clause 54. The method of any of clauses 50-53, wherein the reference points are classified based on a geography value or a feature value of the reference points.
Clause 55. The method of any of clauses 51-54, wherein the points are classified based on a geography value or a feature value of the points.
Clause 56. The method of any of clauses 51-53, wherein a reference point in the reference frame is marked as a reference sample of a sample in the set samples, if the reference point has the least Euclidean distance from the sample among all of reference points in the reference frame.
Clause 57. A method for point cloud coding, comprising: determining, during a conversion between a current frame of a point cloud sequence and a bitstream of the point cloud sequence, global motion information for the current frame based on a plurality of reference frame of the current frame; and performing the conversion based on the global motion information.
Clause 58. The method of clause 57, wherein determining the global motion information comprises: classifying at least a part of points in the current frame based on a set of planar regions, each of the set of planar regions being three-dimensional and having a height equal to a height of a bounding box of the current frame; and determining the global motion information based on the classification.
Clause 59. The method of clause 57, wherein determining the global motion information comprises: assigning a target point in the current frame to one of a plurality of space units for a global motion estimation process of the current frame; classifying the target point into a set of classes; and determining the global motion information based on the classification.
Clause 60. The method of any of clauses 1-59, wherein the conversion includes encoding the current frame into the bitstream.
Clause 61. The method of any of clauses 1-59, wherein the conversion includes decoding the current frame from the bitstream.
Clause 62. An apparatus for processing point cloud data comprising a processor and a non-transitory memory with instructions thereon, wherein the instructions upon execution by the processor, cause the processor to perform a method in accordance with any of Clauses 1-61.
Clause 63. A non-transitory computer-readable storage medium storing instructions that cause a processor to perform a method in accordance with any of Clauses 1-61.
Clause 64. A non-transitory computer-readable recording medium storing a bitstream of a point cloud sequence which is generated by a method performed by a point cloud processing apparatus, wherein the method comprises: classifying a target point in a current frame of the point cloud sequence into a first set of classes based on a second set of thresholds, the number of thresholds in the second set being larger than the number of classes in the first set; and generating the bitstream based on the classification.
Clause 65. A method for storing a bitstream of a point cloud sequence, comprising: classifying a target point in a current frame of the point cloud sequence into a first set of classes based on a second set of thresholds, the number of thresholds in the second set being larger than the number of classes in the first set; generating the bitstream based on the classification; and storing the bitstream in a non-transitory computer-readable recording medium.
Clause 66. A non-transitory computer-readable recording medium storing a bitstream of a point cloud sequence which is generated by a method performed by a point cloud processing apparatus, wherein the method comprises: classifying a target point in a current frame of the point cloud sequence into a first set of classes based on a second set of thresholds, the number of thresholds in the second set being equal to the number of classes in the first set, at least one threshold in the second set is generated based on a further frame of the point cloud sequence; and generating the bitstream based on the classification.
Clause 67. A method for storing a bitstream of a point cloud sequence, comprising: classifying a target point in a current frame of the point cloud sequence into a first set of classes based on a second set of thresholds, the number of thresholds in the second set being equal to the number of classes in the first set, at least one threshold in the second set is generated based on a further frame of the point cloud sequence; generating the bitstream based on the classification; and storing the bitstream in a non-transitory computer-readable recording medium.
Clause 68. A non-transitory computer-readable recording medium storing a bitstream of a point cloud sequence which is generated by a method performed by a point cloud processing apparatus, wherein the method comprises: classifying a target point in a current frame of the point cloud sequence into a first set of classes based on a second set of thresholds, the number of thresholds in the second set being equal to the number of classes in the first set, at least one threshold in the second set being generated based on a histogram of geometry features of points in the point cloud sequence, the histogram being generated based on a characteristic of the point; and generating the bitstream based on the classification.
Clause 69. A method for storing a bitstream of a point cloud sequence, comprising: classifying a target point in a current frame of the point cloud sequence into a first set of classes based on a second set of thresholds, the number of thresholds in the second set being equal to the number of classes in the first set, at least one threshold in the second set being generated based on a histogram of geometry features of points in the point cloud sequence, the histogram being generated based on a characteristic of the point; generating the bitstream based on the classification; and storing the bitstream in a non-transitory computer-readable recording medium.
Clause 70. A non-transitory computer-readable recording medium storing a bitstream of a point cloud sequence which is generated by a method performed by a point cloud processing apparatus, wherein the method comprises: classifying at least a part of points in a current frame of the point cloud sequence based on a set of planar regions, each of the set of planar regions being three-dimensional and having a height equal to a height of a bounding box of the current frame; and generating the bitstream based on the classification.
Clause 71. A method for storing a bitstream of a point cloud sequence, comprising: classifying at least a part of points in a current frame of the point cloud sequence based on a set of planar regions, each of the set of planar regions being three-dimensional and having a height equal to a height of a bounding box of the current frame; generating the bitstream based on the classification; and storing the bitstream in a non-transitory computer-readable recording medium.
Clause 72. A non-transitory computer-readable recording medium storing a bitstream of a point cloud sequence which is generated by a method performed by a point cloud processing apparatus, wherein the method comprises: classifying reference points in a reference frame of a current frame of the point cloud sequence into a set of classes; generating a set of reference samples based on reference points classified into the same class; and generating the bitstream based on the set of reference samples.
Clause 73. A method for storing a bitstream of a point cloud sequence, comprising: classifying reference points in a reference frame of a current frame of the point cloud sequence into a set of classes; generating a set of reference samples based on reference points classified into the same class; generating the bitstream based on the set of reference samples; and storing the bitstream in a non-transitory computer-readable recording medium.
Clause 74. A non-transitory computer-readable recording medium storing a bitstream of a point cloud sequence which is generated by a method performed by a point cloud processing apparatus, wherein the method comprises: determining global motion information for a current frame of the point cloud sequence based on a plurality of reference frame of the current frame; and generating the bitstream based on the global motion information.
Clause 75. A method for storing a bitstream of a point cloud sequence, comprising: determining global motion information for a current frame of the point cloud sequence based on a plurality of reference frame of the current frame; generating the bitstream based on the global motion information; and storing the bitstream in a non-transitory computer-readable recording medium.

### Example Device

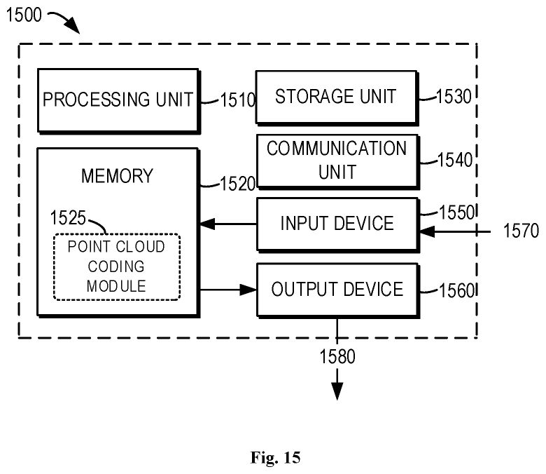

FIG. 15 illustrates a block diagram of a computing device 1500 in which various embodiments of the present disclosure can be implemented. The computing device 1500 may be implemented as or included in the source device 110 (or the GPCC encoder 116 or 200) or the destination device 120 (or the GPCC decoder 126 or 300).

It would be appreciated that the computing device 1500 shown in FIG. 15 is merely for purpose of illustration, without suggesting any limitation to the functions and scopes of the embodiments of the present disclosure in any manner.

As shown in FIG. 15, the computing device 1500 includes a general-purpose computing device 1500. The computing device 1500 may at least comprise one or more processors or processing units 1510, a memory 1520, a storage unit 1530, one or more communication units 1540, one or more input devices 1550, and one or more output devices 1560.

In some embodiments, the computing device 1500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1500 can support any type of interface to a user (such as “wearable” circuitry and the like).

The processing unit 1510 may be a physical or virtual processor and can implement various processes based on programs stored in the memory 1520. In a multi-processor system, multiple processing units execute computer executable instructions in parallel so as to improve the parallel processing capability of the computing device 1500. The processing unit 1510 may also be referred to as a central processing unit (CPU), a microprocessor, a controller or a microcontroller.

The computing device 1500 typically includes various computer storage medium. Such medium can be any medium accessible by the computing device 1500, including, but not limited to, volatile and non-volatile medium, or detachable and non-detachable medium. The memory 1520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1530 may be any detachable or non-detachable medium and may include a machine-readable medium such as a memory, flash memory drive, magnetic disk or another other media, which can be used for storing information and/or data and can be accessed in the computing device 1500.

The computing device 1500 may further include additional detachable/non-detachable, volatile/non-volatile memory medium. Although not shown in FIG. 15, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1540 communicates with a further computing device via the communication medium. In addition, the functions of the components in the computing device 1500 can be implemented by a single computing cluster or multiple computing machines that can communicate via communication connections. Therefore, the computing device 1500 can operate in a networked environment using a logical connection with one or more other servers, networked personal computers (PCs) or further general network nodes.

The input device 1550 may be one or more of a variety of input devices, such as a mouse, keyboard, tracking ball, voice-input device, and the like. The output device 1560 may be one or more of a variety of output devices, such as a display, loudspeaker, printer, and the like. By means of the communication unit 1540, the computing device 1500 can further communicate with one or more external devices (not shown) such as the storage devices and display device, with one or more devices enabling the user to interact with the computing device 1500, or any devices (such as a network card, a modem and the like) enabling the computing device 1500 to communicate with one or more other computing devices, if required. Such communication can be performed via input/output (I/O) interfaces (not shown).

In some embodiments, instead of being integrated in a single device, some or all components of the computing device 1500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1500 may be used to implement point cloud encoding/decoding in embodiments of the present disclosure. The memory 1520 may include one or more point cloud coding modules 1525 having one or more program instructions. These modules are accessible and executable by the processing unit 1510 to perform the functionalities of the various embodiments described herein.

In the example embodiments of performing point cloud encoding, the input device 1550 may receive point cloud data as an input 1570 to be encoded. The point cloud data may be processed, for example, by the point cloud coding module 1525, to generate an encoded bitstream. The encoded bitstream may be provided via the output device 1560 as an output 1580.

In the example embodiments of performing point cloud decoding, the input device 1550 may receive an encoded bitstream as the input 1570. The encoded bitstream may be processed, for example, by the point cloud coding module 1525, to generate decoded point cloud data. The decoded point cloud data may be provided via the output device 1560 as the output 1580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
classifying, during a conversion between a current frame of a point cloud sequence and a bitstream of the point cloud sequence, at least a part of points in the current frame based on a set of planar regions, each of the set of planar regions being three-dimensional and having a height equal to a height of a bounding box of the current frame; and
performing the conversion based on the classification.

2. The method of claim 1, wherein each of the set of planar regions is cuboid, and each point in the current frame is assigned to one of the set of planar regions based on coordinates of the point, or
wherein a reference frame of the current frame comprises at least one reference planar regions, and a reference point in the reference frame belongs to at least one reference planar regions, or
wherein, for a planar region in the current frame, a reference frame of the current frame comprises or does not comprise a reference planar region corresponding to the planar region.

3. The method of claim 1, wherein whether a point in a planar region is to be classified is dependent on a reference planar region in a reference frame of the current frame, the reference planar region corresponding to the planar region.

4. The method of claim 3, wherein the point is classified, if at least one reference points belong to the reference planar region.

5. The method of claim 1, wherein how to classify a point in a planar region is dependent on a classification condition, or
wherein the part of points is classified into a first set of classes based on a plurality of thresholds, the first set of classes comprising a first class associated with object points and a second class associated with road points.

6. The method of claim 1, wherein classifying the target point comprises:
assigning the target point to one of a plurality of space units for a global motion estimation process of the current frame; and
classifying the target point based on the assignment.

7. The method of claim 6, wherein a reference frame of the current frame comprises at least one reference space units, and a reference point in the reference frame belongs to at least one reference space units.

8. The method of claim 7, wherein the at least one reference space units is at least one reference blocks or at least one planar regions, each of at least one planar regions being three-dimensional and having a height equal to a height of a bounding box of the current frame.

9. The method of claim 7, further comprising:
assigning a reference point of the target point to the at least one reference space units, the reference point being in the reference frame, and
marking a reference space unit if a reference point is assigned to the reference space unit.

10. The method of claim 6, wherein, for a space unit in the current frame, a reference frame of the current frame comprises or does not comprise a reference space unit corresponding to the space unit.

11. The method of claim 6, wherein performing the conversion comprises:
classifying at least a part of points in the current frame into the first set of classes, whether a point in a space unit is to be classified being dependent on a reference space unit in a reference frame of the current frame, the reference space unit corresponding to the space unit; and
performing the conversion based on the classification.

12. The method of claim 11, wherein the point is classified, if at least one reference points belong to the reference space unit, or
wherein how to classify a point in a space unit is dependent on a classification condition, or
wherein the first set of classes comprise a first class associated with object points and a second class associated with road points, and the part of points is classified into the first class or the second class based on a plurality of thresholds.

13. The method of claim 1, wherein performing the conversion based on the classification comprises:
determining global motion information for the current frame based on the classification; and
performing the conversion based on the global motion information.

14. The method of claim 13, wherein the global motion information comprises a global motion matrix determined by a least mean square (LMS) algorithm with samples and reference samples, the samples being determined based on points in the current frame, the reference samples being determined based on reference points in a reference frame of the current frame, or
wherein the global motion information comprises a global motion matrix, and performing the conversion based on the global motion information comprises:
obtaining a reference frame with motion compensation by applying the global motion matrix to all of points in a reference frame of the current frame; and
performing the conversion based on the reference frame with motion compensation.

15. The method of claim 1, wherein the conversion includes encoding the current frame into the bitstream, or wherein the conversion includes decoding the current frame from the bitstream.

16. A method for point cloud coding, comprising:
determining, during a conversion between a current frame of a point cloud sequence and a bitstream of the point cloud sequence, global motion information for the current frame based on a plurality of reference frame of the current frame; and
performing the conversion based on the global motion information.

17. The method of claim 16, wherein determining the global motion information comprises:
classifying at least a part of points in the current frame based on a set of planar regions, each of the set of planar regions being three-dimensional and having a height equal to a height of a bounding box of the current frame; and
determining the global motion information based on the classification.

18. The method of claim 16, wherein determining the global motion information comprises:
assigning a target point in the current frame to one of a plurality of space units for a global motion estimation process of the current frame;
classifying the target point into a set of classes; and
determining the global motion information based on the classification.

19. The method of claim 16, wherein the conversion includes encoding the current frame into the bitstream, or wherein the conversion includes decoding the current frame from the bitstream.

20. A method for point cloud coding, comprising:
classifying, during a conversion between a current frame of a point cloud sequence and a bitstream of the point cloud sequence, at least one of:
a target point in the current frame into a first set of classes based on a second set of thresholds, the number of thresholds in the second set being larger than the number of classes in the first set,
a target point in the current frame into a first set of classes based on a second set of thresholds, the number of thresholds in the second set being equal to the number of classes in the first set, at least one threshold in the second set is generated based on a further frame of the point cloud sequence,
a target point in the current frame into a first set of classes based on a second set of thresholds, the number of thresholds in the second set being equal to the number of classes in the first set, at least one threshold in the second set being generated based on a histogram of geometry features of points in the point cloud sequence, the histogram being generated based on a characteristic of the point; and
performing the conversion based on the classification.
